(19) United States
(12) Patent Application Publication
(10) Pub. No.: US 2026/0284999 A1
(43) Pub. Date: Sep. 24, 2026

(54) MACHINE AND METHOD FOR FORMING BAGS OF FLEXIBLE MATERIAL

(71) Applicant: ILAPAK ITALIA S.P.A., Foiano della Chiana (IT)

(72) Inventors: Stefano Rolleri, Foiano della Chiana (AR) (IT); Paolo Rubbini, Foiano della Chiana (AR) (IT); Emanuele Sarcoli, Foiano della Chiana (AR) (IT)

(21) Appl. No.: 19/473,836

(22) PCT Filed: Apr. 8, 2024
(86) PCT No.: PCT/IB2024/053427

§ 371 Date: Oct. 9, 2025

(30) Foreign Application Priority Data
May 2, 2023 (IT) 102023000008496

(51) Int. Cl. B31B 70/26; B31B 70/00; B31B 70/10; B31B 70/16; B31B 70/36; B31B 70/64; B31B 70/88; B31B 155/00; B31B 160/20

(52) U.S. Cl. CPC B31B 70/266; B31B 70/005; B31B 70/008; B31B 70/10; B31B 70/16; B31B 70/36; B31B 70/642; B31B 70/644; B31B 70/645; B31B 70/88; B31B 2155/0014; B31B 2160/20

(57) ABSTRACT

A machine for forming bags wherein the machine includes a conveying element configured to advance a film and a forming element configured to fold the film along at least one folding line to superimpose two flaps of the film forming a folded film with an open longitudinal side. The machine also includes a processing path and a transverse sealing element arranged along the processing path configured to make on the folded film a transverse sealing to create two opposite sealed edges for each bag. The processing path includes a first straight section that departs from the forming element and a substantially parallel second straight section that is downstream of the first straight section such that portions of the folded film along the first and second straight sections lay on respective planes that face each other wherein the transverse sealing element is arranged along the second straight section.

The present invention relates to a machine and a method for forming bags of a flexible film.

This type of bags comprises a closed base and two opposite sealed edges, and an opening mouth, opposite to said closed base, through which said bags can be filled.

In the machines used to form these bags, a film is fed by a supply reel. The film is appropriately folded and sealed to make a row of identical bags joined to each other.

In such machines, folding means fold the film coming from the supply reel and fold it into a specific conformation according to which it can then be sealed along predefined lines by one or more sealing means to form a bag. One of the critical aspects of such machines is large footprint, as they are generally quite long. Furthermore, if the size of the produced bags is changed, it is necessary to adequately position the processing means of the machine. An example of this aspect might be the need to distance the sealing means further apart from each other when increasing the size of the bags requested, thus further increasing the length occupied by the machine.

Generally, folding and sealing means are positioned along a single film processing line.

Horizontal machines are known in which the supply reel of the flexible film, forming means and sealing means are placed one after the other along a horizontal longitudinal processing path. These machines are generally the most extended in terms of footprint. Examples include the one described in the patent US-A-8707659.

Machines with vertical development are also known. This type of machine has a much smaller footprint than those with horizontal development as the forming and sealing means are arranged substantially in succession to one another along a common vertical axis with the forming means positioned at the top of the machine and the transverse sealing means at the bottom, with the flexible film advancing downwards and subsequently exiting at the bottom of the machine.

Despite having a smaller footprint than machines with horizontal development, this type of machine has some drawbacks arising from the specific arrangement of the various components. One drawback is represented by the position of the forming means since, especially during the initial production operations, when the supply reel is placed on the machine, the film must be positioned manually by the operator on the forming means, and since these are positioned in the upper part of the machine, the user needs ladders or platforms to be able to reach them and carry out this operation, with consequent extension of the time required, difficulty in a correct positioning of the film and possible dangers deriving from working at a certain height. A further drawback of such machines is the sizing and positioning of the transverse sealing means, since in the production of bags of a certain width, these transverse sealing means have to be spaced further apart, increasing the height of the machine considerably.

An example of this type of machine is illustrated in the patent EP3395709 B1.

It appears clear that the problems with known machines are associated with their horizontal footprint or their vertical extension, and that there is therefore a need for a flexible bag forming machine having a small footprint and whose components are arranged in positions which are easily accessible by the user, while maintaining good flexibility in the variability of bag sizes of possible production.

One purpose of the present invention is to provide a machine for forming bags of flexible material having a small footprint.

A further purpose of the present invention is to provide a machine for forming bags of flexible material in which the components of said machine are arranged in positions which are easily accessible by the user.

An additional purpose of the present invention is to provide a method for forming flexible bags in which forming is carried out in a small space.

In accordance with the present invention, such a machine is provided according to claim 1.

The dependent claims of the present invention outline advantageous embodiments of the invention.

The invention may be better understood and implemented by reference to the accompanying drawings which illustrate an exemplary and non-limiting form of implementation wherein:

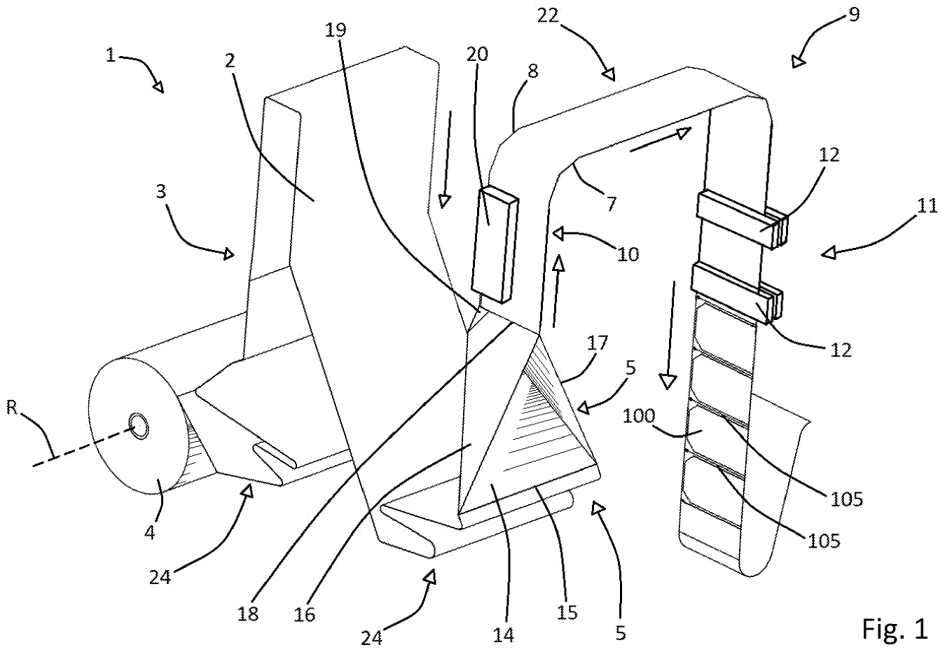

FIG. 1 is a schematic view of a machine according to the present invention;

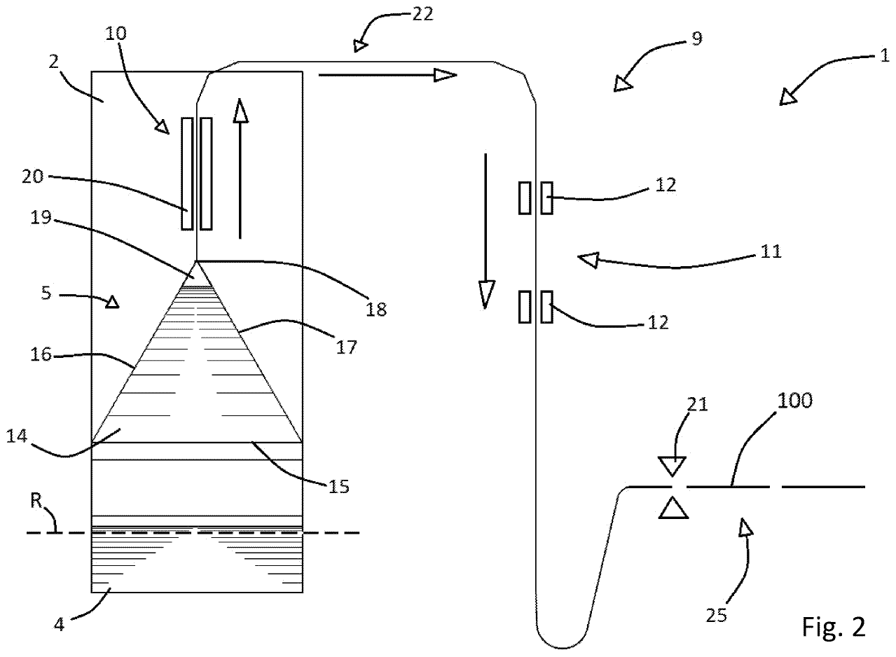

FIG. 2 is a front schematic side view of the machine according to FIG. 1;

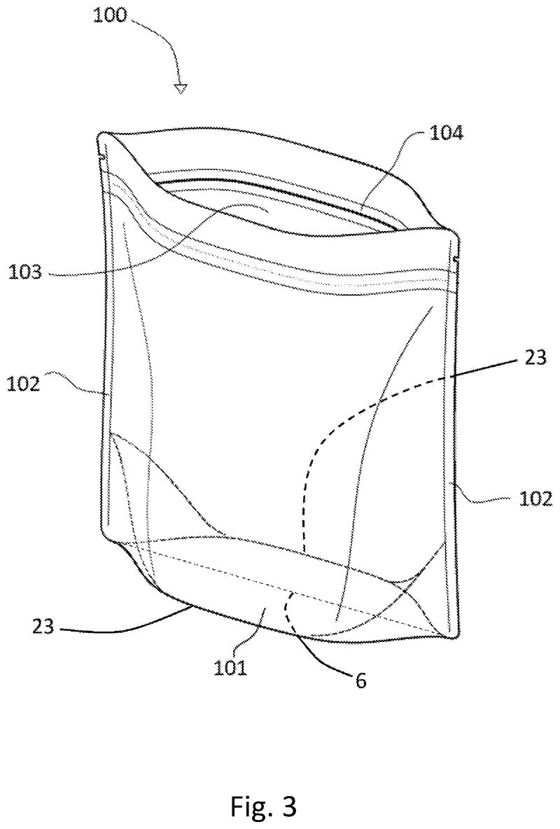

FIG. 3 is a schematic view of a bag in an open configuration made by the machine according to the present invention.

With reference to the annexed figures, and in particular to FIG. 1, a machine 1 for forming bags 100 of flexible material is generally indicated.

The bags 100 made of flexible material have a closed base 101, two opposite lateral sealed edges 102 and an opening mouth 103, opposite to the closed base 101.

The machine 1 comprises:
conveying means 3 configured to make a film 2 of flexible material to advance along an advance direction A;
forming means 5 configured to fold the film 2 along at least one folding line 6 so as to bring together and superimpose two flaps of the film 2
forming a folded film with an open longitudinal side 7, and an opposite closed longitudinal side 8 developing along the folding line 6, said open 7 and closed 8 longitudinal sides being parallel to each other;
a processing path 9 of the folded film 2 departing from the forming means 5, said open longitudinal side 7 being aligned parallel to said processing path 9; and
transverse sealing means 12 arranged along said processing path 9 and configured to make on said folded film 2 a transverse sealing 105 which extends between said closed longitudinal side 8 and said open longitudinal side 7 of the folded film, so as to create said two opposite sealed lateral edges 102 for each bag 100.

According to the present invention, the processing path 9 comprises a first straight section 10 which directly departs from said forming means 5 and a second straight section 11 which is downstream to the first straight section 10 with respect to the advance direction A. The first 10 and second 11 straight sections are spaced apart from each other and run substantially in parallel, in such a way that the portion of the folded film 2 along the first straight section 10 and the portion of the folded film 2 along the second straight section 11 lay on a respective plane which face each other. Moreover, the transverse sealing means 12 are arranged along said second straight section 11 of the processing path (9).

As film can be used plastic material or film made of paper-based material. Generally, the film 2 of flexible material comes from a supply reel 4 rotating about an axis of rotation R.

The conveying means 3 may be configured as rollers or bars or with any conformation that allows the film 2 of flexible material to advance. Conveniently, the conveying means 3 may comprise one or more movable parts which, moved in rotation by means of suitable motor means, drag the film 2 placed in contact with the surface of said conveying means.

According to a specific embodiment, the conveying means 3 comprise dragging cylinders arranged along said processing path 9 and configured to drag the film 2 along the advance direction A.

The first straight section 10 and second straight section 11 are arranged at a distance which dependents on the footprint of specific processing means, including said transverse sealing means 12 operating on the folded film 2 along the second straight section 11 of the processing path 9.

Said transverse sealing means 12 comprise sealing elements such as, for example, heated bars, ultrasonic sealers, or other means known in the art configured to seal flexible packaging material.

The transverse sealing means 12 are preferably configured to seal the folded film 2 intermittently.

The transverse sealing means 12 are configured to perform a plurality of transverse sealings 105 simultaneously. In particular, the transverse sealing means 12 seal the lateral edges 102 of a plurality of bags 100 at the same time thereby making a plurality of transverse seals simultaneously on the folded film 2.

In accordance with specific embodiments, the machine 1 may comprise at least one buffer station 24 configured to compensate for accelerations or decelerations in the advancement of the film 2. Such variations in the advancement of the film 2 may, for example, be due to intermittent operation of the transverse sealing means 12.

The transverse sealings 105 create the lateral edges 102 and the corresponding opening mouths 103 of the bags 100.

According to a specific embodiment, the forming means 5 comprise a folding plate 14 having a substantially triangular shape with a fist side configured as a leading edge 15 and two lateral edges from which a first flap 16 and a second flap 17 of the film 2 depart to meet along a meeting line 18 opposite the leading edge 15.

In particular, the leading edge 15 extends substantially parallel to the axis of rotation R of the supply reel 4 and said meeting line 18 is arranged substantially perpendicular to said leading edge 15 of the folding plate 14. In accordance with some embodiments, the folding plate 14 can further comprise two lateral plates (not illustrated in the figures) each respectively departing from said two lateral edges, along a transverse disposition and having a substantially triangular conformation with a respective common edge arranged along said line 18.

According to different embodiment, the forming means 5 further comprise a folding element 19 configured to create a pair of secondary folds 23 opposite each other and arranged on the sides of said folding line 6 so as to form a “W” shaped gusset along the closed longitudinal side 8 of the folded film 2. Once opened, this gusset creates the base of the bag 100. According to one embodiment, the secondary folds 23 are arranged substantially parallel to the open longitudinal side 7 of the folded film.

According to a preferred embodiment, the machine 1 can comprise longitudinal sealing means 20 arranged along said first straight section 10. The longitudinal sealing means 20 are configured to seal the folded film 2 along a longitudinal direction parallel to the said first straight section 10.

When the bag includes the pair of secondary folds 23 made by the folding element 19, the longitudinal sealing means 20 seal the film 2 along said pair of secondary folds 23.

The longitudinal sealing means 20, similarly to the transverse sealing means 12, comprise sealing elements such as, for example, heating elements, ultrasonic sealers or other means in the known art configured for sealing flexible packaging material. The sealing elements of such longitudinal sealing means 20 may conveniently be shaped as bars having a longitudinal arrangement parallel to the folding line 6. In such embodiment, longitudinal sealings are firstly performed on the film 2 and then the transverse sealings 105 are performed, so as to create, for each bag 100 to be formed, the base 101 conformed in such a way as to allow a stable support of the bag 100. Such type of bags is commonly identified as doypack or stand-up pack.

According to the preferred embodiment, said longitudinal sealing means 20 are placed in proximity to the forming means 5.

A further embodiment provides the presence of additional sealing elements in said transverse sealing means 12 configured to make oblique sealings between said transverse sealings and said longitudinal sealings. Preferably the additional sealing elements are arranged in conjunction with the sealing elements of said transverse sealing means 12.

According to different embodiments, downstream of said forming means 5, along the advancement direction of the film 2, web feeding means may be arranged which feeds a web for creating a resealable opening 104 of the opening mouth 103. Such web feeding means are configured to provide, parallel to the open longitudinal side 7, within the folded film 2, a re-sealable opening web for the bag 100.

Said configuration provides the forming of bags 100 which, once opened for the first time to access the product contained therein, it can be closed again by applying pressure to said tape. According to said embodiment, the longitudinal sealing means 20 are further configured to perform an additional longitudinal sealing between said tape and the flaps of the film 2. As is clear, the additional welding does not lead to closure of the open longitudinal side 7 of the folded film 2.

In accordance with the preferred embodiment, said first 10 and second 11 straight sections lay vertically. More preferably, the conveying means 3 are configured to advance the folded film on the first straight section 10 along an ascending direction, while on said second straight section 11 along a descending direction.

Conveniently, as visible in FIG. 2, the longitudinal sealing means 20 are arranged at substantially an equal height as the transverse sealing means 12.

In other words, the longitudinal sealing means 20 and the transverse sealing means 12 face each other.

According to the preferred embodiment, the processing path 9 of the film 2 further comprises a third straight section 22 which joints the first straight section 10 and the second straight section 11, wherein the third straight section 22 is arranged transversely with respect to the first 10 and second 11 straight sections. In the illustrated example, the third straight section 22 is arranged horizontally.

According to the specific embodiment, on the third straight section 22, the movement of the film 2 is according to a direction substantially perpendicular to those of the first straight section 10 and the second straight section 11.

Along said third straight section 22 can be arranged accessory stations configured to carry out further operations on the film 2. Those accessory stations are chosen among labeller, puncher, or printer.

Further embodiments provide that the length of the first straight section 10 of the processing path 9 is shorter than the length of the second straight section 11.

Further, in accordance with alternative embodiments, the second straight section 11 is substantially as long as said first straight section 10 plus the vertical extension of the forming means 5.

According to a preferred embodiment, the machine further comprises a cutting device 21 arranged downstream said transverse sealing means 12 and configured to cut the film 2 along said transverse sealing 105, so as to sever the bags 100 from each other.

According to the present invention, there is also a method for forming the bags 100 of flexible material.

The method comprises the steps of:
feeding a flexible film 2 from a supply reel 4 according to an advance direction A;
folding the film 2 along at least one folding line 6 by means of forming means 5, so as to bring together and superimpose two flaps of the film 2 forming a folded film 2 with an open longitudinal side 7 and a closed opposite longitudinal side 8 developing along the folding line 6, wherein the open 7 and closed 8 longitudinal sides are parallel to each other;
advancing the folded film 2 along a processing path 9 with said open longitudinal side 7 parallel to said processing path 9;
transverse sealing the film 2 between said closed longitudinal side 8 and said open longitudinal side 7 of the folded film, so as to create said two opposite sealed lateral edges 102 for each bag 100.

According to the invention, the method provides that said processing path 9 comprises a first straight section 10 which directly departs from said forming means 5 and a second straight section 11 which is downstream to the first straight section 10 with respect to the advance direction A.

The first 10 and second 11 straight sections are spaced apart from each other and run substantially in parallel, in such a way that the portion of the folded film 2 along the first straight section 10 and the portion of the folded film 2 along the second straight section 11 lay on a respective plane which face each other.

Furthermore, the method provides that the step of transverse sealing is carried out along said second straight section 11 of the processing path 9. According to some embodiments, the method further comprises a step of longitudinal sealing the folded film 2 along a longitudinal direction parallel to said first straight section 10, wherein said longitudinal sealing is carried out along said first straight section 10.

According to further embodiments, the method provides that said folding step comprises a secondary folding sub-step in which the film 2 is further folded by creating a pair of opposing secondary folds 23 opposite each other and arranged on the sides of the folding line 6 so as to form a “W” shaped gusset along the closed longitudinal side 8.

Preferably, the longitudinal sealing step is carried out along said pair of secondary folds 23.

According to further embodiments, in said advancing step, the film 2 is moved along a third straight section 22 of the processing path 9, wherein the third straight section 22 joins the first 10 and the second 11 straight sections. In particular, the film 2 is moved along the third straight section 22 substantially perpendicular to the said first 10 and second 11 straight sections.

In accordance with the preferred embodiment of the present invention, said first 10 and second 11 straight sections lay vertically, and said folded film is advanced on the first straight section 10 along an ascending direction, while on said second straight section 11 along a descending direction.

According to further embodiments, the processing path 9 may comprise a fourth straight section 25, arranged downstream of the second straight section 11 and preferably arranged horizontally. In accordance with such embodiments, the cutting device 21 may be arranged along said fourth straight section 25.

According to suitable embodiments, downstream of said cutting device 21 there may be a bag filling machine.

It is understood that modifications and/or additions of parts or steps may be made to the machine for forming bags of flexible material and the method for forming bags 100 of flexible material described so far, in accordance with the scope of protection defined by the claims.

In the following claims, the references in brackets are only intended to facilitate reading and are not to be considered as limiting factors regarding the scope of protection underlying the specific claims.

1. A machine for forming bags of flexible material having a closed base, two opposite lateral sealed edges and an opening mouth opposite to said closed base, said machine comprising:
a conveying element configured to advance a film of flexible material along an advance direction (A);
a forming element configured to fold the flexible film along at least one folding line so as to bring together and superimpose two flaps of the film forming a folded film with an open longitudinal side, and an opposite closed longitudinal side developing along the folding line, said open and closed longitudinal sides being parallel to each other;
a processing path of the folded film departing from the forming means, said open longitudinal side being aligned parallel to said processing path wherein said processing path includes a first straight section which directly departs from said forming means and a second straight section which is downstream to said first straight section with respect to the advance direction (A), said first and second straight sections being spaced apart from each other and running substantially in parallel, so that the portion of the folded film along said first straight section and the portion of the folded film along said second straight section lay on respective planes that face each other; and
at least one transverse sealing element arranged along said processing path wherein said transverse sealing element is arranged along said second straight section of the processing path and configured to make on the folded film a transverse sealing which extends between said closed longitudinal side and said open longitudinal side of the folded film, so as to create said two opposite lateral sealed edges for each bag.

2. The machine according to claim 1, further comprising at least one longitudinal sealing element arranged along said first straight section and configured to seal the folded film along a longitudinal direction parallel to said first straight section

3. The machine according to claim 2, wherein said longitudinal sealing element is placed in proximity to the forming means

4. The machine according to claim 2, wherein said forming element further comprises a folding element configured to create a pair of secondary folds opposite each other and arranged on the sides of the folding line so as to form a “W” shaped gusset along the closed longitudinal side and wherein said longitudinal sealing element is configured to seal the film along said pair of secondary folds.

5. The machine according to claim 1, wherein said first and second straight sections lay vertically.

6. The machine according to claim 1, wherein said conveying element is configured to advance the folded film on said first straight section along an ascending direction, while on said second straight section along a descending direction.

7. The machine according to claim 1, wherein said processing path of the film further comprises a third straight section which joins said first and said second straight sections, said third straight section being arranged transversally with respect to said first and second straight sections.

8. The machine according to claim 7, wherein along said third straight section are arranged accessory stations configured to carry out further operations on the film and chosen among labeller, puncher, or printer.

9. The machine according to claim 1, wherein said forming element comprises a folding plate having a substantially triangular shape with a fist side configured as a leading edge and two lateral edges from which the two flaps of the film depart to meet along a meeting line opposite the leading edge.

10. The machine according to claim 9, wherein said leading edge extends substantially parallel to an axis of rotation (R) of a supply reel of said film of flexible material, and said meeting line (18) is arranged substantially perpendicular to said leading edge of the folding plate.

11. The machine according to claim 1, further comprising a cutting device arranged downstream said transverse sealing element and configured to cut the film along said transverse sealing so as to sever the bags from each other.

12. The machine according to claim 1, wherein said transverse sealing element is configured to seal intermittently.

13. The machine according to claim 1, wherein said conveying element comprises dragging cylinders arranged along said processing path and configured to drag the film along the advance direction (A).

14. A method for forming bags of flexible material having a closed base two opposite lateral sealed edges and an opening mouth opposite to said closed base for filling of the bag said method comprising the following steps:
feeding a flexible film from a supply reel along an advance direction
folding said film along at least one folding line by using a forming element to bring together and superimpose two flaps of the film forming a folded film with an open longitudinal side and an opposite closed longitudinal side developing along the folding line, said open and closed longitudinal sides being parallel to each other;
advancing the folded film along a processing path with said open longitudinal side parallel to said processing path wherein said processing path comprises a first straight section which directly departs from said forming element and a second straight section which is downstream to said first straight section with respect to the advance direction (A), said first and second straight sections being spaced apart from each other and running substantially in parallel, so that the portion of the folded film along said first straight section and the portion of the folded film along said second straight section lay on respective planes that face each other; and
transverse sealing the folded film between said closed longitudinal side and said open longitudinal side of the folded film to create said two opposite lateral sealed edges for each bag wherein said transverse sealing is carried out along said second straight section of the processing path.

15. The method according to claim 14, further comprising longitudinal sealing said the folded film along a longitudinal direction parallel to said first straight section, said longitudinal sealing being carried out along said first straight section.

16. The method according to claim 15, wherein said folding step comprises a secondary folding sub-step in which the film is further folded creating a pair of secondary folds opposite each other and arranged on the sides of said folding line so as to form a “W” shaped gusset along the closed longitudinal side and wherein said longitudinal sealing step is carried out along said pair of secondary folds.

17. The method according to claim 14, wherein said first and second straight sections lay vertically, and the folded film is advanced on said first straight section along an ascending direction, while on said second straight section along a descending direction.

18. The method according to claim 14, wherein the folded film is moved along a third straight section of said processing path which joins said first and said second straight sections, in which the film is moved substantially perpendicular to said first and second straight sections.
